(19) United States
(12) Patent Application Publication
(10) Pub. No.: US 2012/0298386 A1
(43) Pub. Date: Nov. 29, 2012

(54) TOOL FREE ADJUSTABLE TENSION LEVELING HARROW BAR

(75) Inventors: Tom STEFFAN, Cloverdale, OH (US); Mark RECKER, Ottawa, OH (US); Steve HILVERS, Delphos, OH (US)

(73) Assignee: UNVERFERTH MANUFACTURING COMPANY INC., Kalida, OH (US)

(21) Appl. No.: 13/117,956

(22) Filed: May 27, 2011

(51) Int. Cl. A01B 23/00; A01B 49/02; A01B 21/00; A01B 19/02

(52) U.S. Cl. 172/138; 172/684.5; 172/619

(57) ABSTRACT

A tillage support includes a tool free adjustable tension leveling harrow bar that allows for an operator to adjust the tension of a leveling bar tool free. The tillage support includes a tensioning link coupled to a tensioning device. The tensioning link includes a plurality of coupling points. The tillage support includes a leveling bar mount arm with at least one coupling point and capable of being independently rotated about an axis. The leveling bar mount arm can be coupled to the tensioning link by a coupling link, and the coupling link can be adjusted by an operator tool free. The coupling link can engage any of the at least one coupling point of the leveling bar mount arm and the coupling points of the tensioning link, and the tension can be adjusted by engaging different coupling points with the coupling link.

### BACKGROUND OF THE INVENTION

1. Field of the Invention

The present invention relates generally to a system for preparing agricultural field seedbeds. More particularly, the present invention relates to a tool free adjustable tension leveling bar mount.

2. Description of the Related Art

Agricultural field seedbed preparation is an integral prerequisite for successful crop cultivation. There are many factors in preparing what is considered a proper seedbed. Consistency of soil residue, firmness and size of aggregate is critical to planting and emergence of crops.

A harrow leveler bar is one way to mix, firm and break down aggregate to achieve desired consistency. The harrow leveling bar may be made of different designs. For example, the harrow leveling bar can be made of coil tines, which are best suited for applications with heavy vegetation residue, or diagonal round tooth designs, which are best suited for maximum leveling action of the seedbed soil. The harrow leveling bar can also be made of a straight spike tooth bar, which allows for increased residue flow while maintaining a more aggressive leveling action. Harrow leveling bars can be adjustable to accommodate more or less residue and soil leveling action depending on the field requirements. The type of harrow leveling bar that is ideal for a job will vary based on the soil type and field preparation tillage tools.

Typically, machine owners purchase one style of harrow leveling bar that best suits their overall needs. Operators may, however, encounter different conditions from one field to the next that require the leveling bar to be adjusted for optimal performance. Leveling bars are generally spring loaded to allow travel over uneven terrain, and, also, to allow the bars to pass over obstacles, such as rocks. In the past, leveling bars have been adjustable by using tools to change tension on hardware that applies the spring loaded tension. The requirement of tools causes the adjustments to consume much valued time, and requires the operator to carry additional tools to adjust the tension of the leveling bars.

Thus, there is a need for a new and improved system for adjusting the tension of leveling bars.

### SUMMARY OF THE INVENTION

According to an embodiment of the present invention, a tillage support including a tool free adjustable harrow leveling bar is provided. The tillage support includes a frame including a first support member and an extension arm coupled to the first support member. The tillage support also includes a tensioning device coupled to the first support member and the extension arm. The tillage support further includes a tension link coupled to the tensioning device and the first support member, wherein the tension link includes at least two coupling points. The tillage support also includes a leveling bar mount arm rotatably coupled to the first support member, wherein the leveling bar mount arm includes at least one coupling point and is configured to independently rotate about a first axis. The tillage support further includes a coupling link configured to engage the coupling point of the leveling bar mount arm and at least one of the coupling points of the tension link. The coupling link is configured to be adjustable tool free.

According to an embodiment of the present invention, the extension arm includes an end capable of being coupled to additional tillage equipment. According to an embodiment of the present invention the additional tillage equipment is a rolling harrow basket.

According to an embodiment of the present invention, the at least one coupling point is a receiving member. According to an embodiment of the present invention, the coupling link is an elongate member configured to engage the at least one coupling point. According to an embodiment of the present invention, the elongate member is a pin.

According to an embodiment of the present invention, the leveling bar mount arm further includes a coupling plate including at least one coupling point configured to receive the coupling link.

According to an embodiment of the present invention, the tillage support further includes a harrow leveling bar coupled to the leveling bar mount arm.

According to an embodiment of the present invention, a tillage implement is provided, and the tillage implement includes at least one tillage support frame including a first support member, an extension arm coupled to the first support member, a tensioning device coupled to the first support member and the extension arm, and a tension link coupled to the first support member and the tensioning device. The tension link includes at least two coupling points. The tillage implement further includes at least one tillage support member coupled to the first support member and including an end configured to couple to a farm implement. The tillage implement also includes at least one leveling bar mount arm rotatably coupled to the first support member, wherein the at least one leveling bar mount arm includes at least one coupling point and is configured to independently rotate about a first axis. The tillage implement further includes at least one coupling link configured to engage the coupling point of the at least one leveling bar mount arm and at least one of the coupling points of the tension link. The at least one coupling link can be configured to be adjustable tool free.

According to an embodiment of the present invention, the tillage implement further includes a rolling harrow basket coupled to an end of the extension arm. According to an embodiment of the present invention, the tillage implement further includes a harrow leveling bar coupled to the at least one leveling bar mount arm.

The above and/or other aspects, features and/or advantages of various embodiments will be further appreciated in view of the following description in conjunction with the accompanying figures. Various embodiments can include or exclude different aspects, features or advantages where applicable. In addition, various embodiments can combine one or more aspects, features, or advantages where applicable. The descriptions of the aspects, features, or advantages of a particular embodiment should not be construed as limiting any other embodiment of the claimed invention.

### BRIEF SUMMARY OF THE DRAWINGS

FIG. 1 is a side view of a tillage support having a tension link according to an embodiment of the present invention.

FIG. 2 is a side view of a tillage support having a tension link and a leveling bar mounting arm according to an embodiment of the present invention.

FIG. 3 is a side view of a tillage support having a tension link and a leveling bar mounting arm according to an embodiment of the present invention.

FIG. 4 is a side view of a tillage support having a tension link and a leveling bar mounting arm according to an embodiment of the present invention.

FIG. 5 is a side view of a tillage support having a tension link and a leveling bar mounting arm according to an embodiment of the present invention.

FIG. 6 is a side view of a tillage support having a tension link and a leveling bar mounting arm according to an embodiment of the present invention.

FIG. 7 is a perspective view of a tillage implement with a rolling harrow basket and a leveling bar according to an embodiment of the present invention.

### DETAILED DESCRIPTION OF THE DRAWINGS

While the present invention may be embodied in many different forms, a number of illustrative embodiments are described herein with the understanding that the present disclosure is to be considered as providing examples of the principles of the invention and such examples are not intended to limit the invention to the preferred embodiment described herein and/or illustrated herein.

In embodiments of the present invention, an operator is capable of adjusting the position and tension of a leveling bar mount arm, and, thus, a leveling bar, without tools. The following includes non-limiting examples of a tool free adjustable tension leveling harrow bar according to embodiments of the present invention. It should be appreciated that the following examples are provided for illustration and the present invention is not intended to be limited to the embodiments described herein.

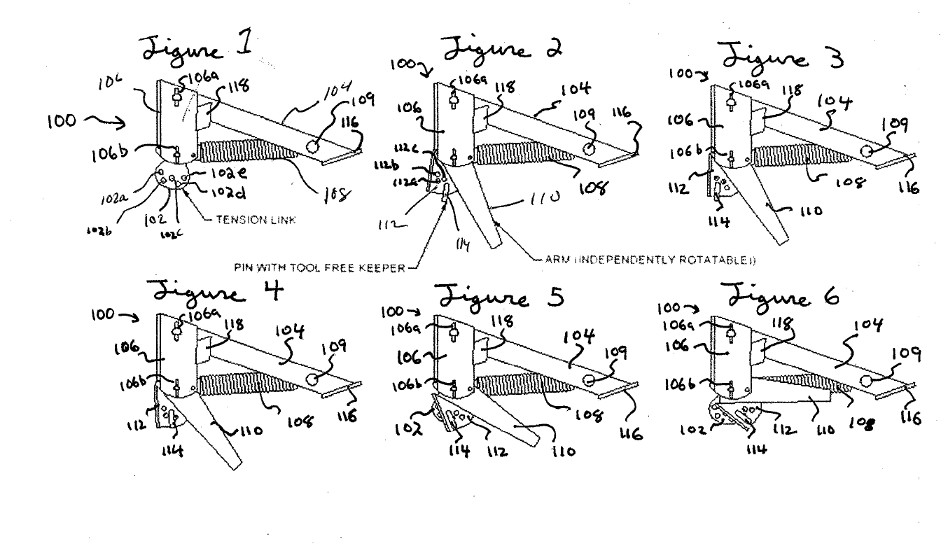

FIG. 1 is a side view of a tillage support having a tension link for a harrow according to an embodiment of the present invention. A tillage support 100 includes a tension link 102, an extension arm 104, a tension link support member 106 and a tensioning device 108. The tension link 102 includes a plurality of coupling points 102a-102e. In an embodiment of the present invention, the plurality of coupling points 102a-102e are holes provided in the tension link 102.

The tension link 102 is coupled to the tension device 108, which is coupled to the extension arm 104 at position 109. In an embodiment of the present invention, the tensioning device 108 is a spring. The tension link 102 is further coupled to the tension link support member 106. The tension link support member 106 is coupled to the extension arm 104 at an end opposite the tension link 102. In an embodiment of the present invention, the tension link support member 106 has at least two coupling points 106a and 106b. In an embodiment of the present invention, the coupling points 106a and 106b are an elongated opening, and components can be coupled to the tension link support member 106 at a plurality of points within each of the coupling points 106a and 106b.

In an embodiment of the present invention, the extension arm 104 includes an end 116 configured to couple with tillage equipment, such as a rolling harrow basket. In an embodiment of the present invention, the end 116 of the arm 104 is flanged so that it can be coupled with a tillage implement. In an embodiment of the present invention, the tillage support 100 further includes an extension arm support 118. The extension arm support 118 is coupled to the tension link support member 106 and the extension arm 104, and is configured to provide additional support to the extension arm 104.

FIG. 2 is a side view of a tension link and a leveling bar mount arm according to an embodiment of the present invention. The leveling bar mount arm 110 is rotatably coupled to the tension link support member 106, and the leveling bar mount arm 110 is configured to rotate independent of the other components of the tillage support 100 when the leveling bar mount arm 110 is not coupled to the tension link 102. The leveling bar mount arm 110 can be coupled to the tension link 110 (coupling is described in further detail below), and, when coupled to the tension link 102, the leveling bar mount arm 110 is in communication with the tensioning device 108 via the tension link 102. The leveling bar mount arm 110 is configured to couple with a leveling bar. In an embodiment of the present invention, the leveling bar can be coil tines, diagonal round teeth, a straight spike tooth bar or any other leveling bar design. The tension exerted on the leveling bar mount arm 110 by the tensioning device 108 allows the leveling bar to travel over uneven terrain and to trip over obstacles such as rocks.

The leveling bar mount arm 110 includes a coupling plate 112. The coupling plate 112 includes a plurality of coupling points 112a-112d. In an embodiment of the present invention, the coupling points 112a-112d are holes. The coupling plate 112 is positioned to extend over the tension link 102 such that the coupling points 112a-112d of the coupling plate 112 can be aligned with the coupling points 102a-102e of the tension link 102. The coupling plate 112 can be coupled to the tension link 102 by a coupling member 114. Each of the coupling points 112a-112d of the coupling plate 112 and the coupling points 102a-102e of the tension link 102 are configured to receive the coupling member 114. In an embodiment of the present invention, the coupling member 114 can be a pin with a tool free keeper.

The coupling member 114 is manually adjustable from a coupled position, i.e., the coupling member 114 is coupled to at least one coupling point 102a-102e of the tension link 102 and at least one coupling point 112a-112d of the coupling plate 112, to an uncoupled position, i.e., the coupling member 114 is not coupled to at least one of the tension link 102 or the coupling plate 112.

In an embodiment of the present invention, the leveling bar mount arm 110 can be rotated into a position in which a plurality of the coupling points 102a-102e of the tension link 102 and a plurality of the coupling points 112a-112d of the coupling plate 112 are aligned coaxially. In such a position, the coupling member 114 can be received by any one of the plurality of coaxially aligned coupling points 102a-102e of the tension link 102 and coupling points 112a-112d of the coupling plate 112, and the tension on the leveling bar mount arm 110 can be adjusted by changing which coaxially aligned coupling points receive the coupling member 114. In an embodiment of the present invention, the leveling bar mount arm 110 can be rotated into a plurality of positions in which at least two coupling points 102a-102e of the tension link and coupling points 112a-112d of the coupling plate 112 are coaxially aligned.

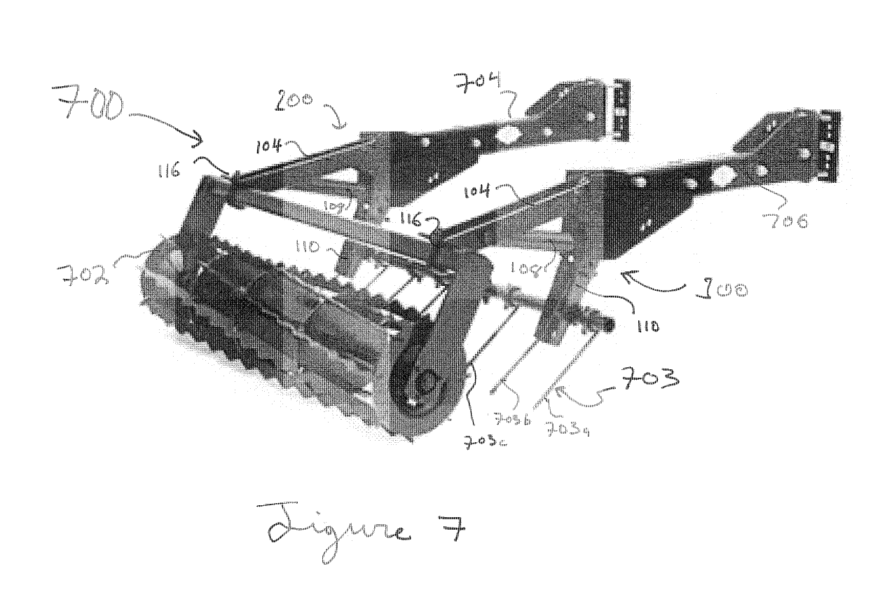

FIGS. 3-6 show the leveling bar mount arm 110 coupled to the tension link 102 in various positions. The tension of the leveling bar mount arm 110 can be adjusted by changing the coupling point 102a-102e of the tension link 102 that receives the coupling member 114. The position of the leveling bar mount arm 110 can be adjusted by positioning the coupling member 114 in an uncoupled position and rotating the leveling bar mount arm 110. The leveling bar mount arm 110 is independently rotatable, and an operator can manually rotate the leveling bar mount arm 110 into a plurality of positions. The leveling bar mount arm 110 can be maintained at a desired position by placing the coupling member 114 in a coupled position.

FIG. 7 is a perspective view of tillage implement with a rolling harrow basket and a leveling bar according to an embodiment of the present invention. The tillage implement 700 includes a rolling harrow basket 702, a leveling bar 703, and mounting arms 704 and 706. The rolling harrow basket 702 is coupled to an end 116 of the extension arm 104 of the tillage support 100. The harrow leveling bar 703 includes a plurality of coil tines 703a-703c to mix, firm and break down aggregate to achieve desired consistency. In an embodiment of the present invention, the leveling bar 703 can be another leveling bar design known in the art, e.g., diagonal round tooth bar or straight spike tooth bar.

The tillage implement 700 is coupled to a farm implement, such as a field cultivator, by the mounting arms 704 and 706. The mounting arms 704 and 706 are coupled to a farm implement at an end, and are coupled to the tillage support 100 at an opposite end. In an embodiment of the present invention, the mounting arms 704 and 706 are coupled to the tension link support members 106 of the tillage support 100.

In operation, the tillage implement 700 is pulled by a farm implement, and the leveling bar 703 mixes, firms and breaks down aggregate before the rolling harrow basket 702 further smoothes and breaks down the soil. The tension and the angle of the leveling bar 703 must be adjusted for optimal performance from field-to-field, as described above, by, e.g., adjusting the coupling 114 of the tension link, without the need for a tool. An operator can manually adjust the tension and angle of the leveling bar 703 by adjusting the coupling member 114.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention. For example, the tensioning device could be a hydraulic cylinder instead of a spring.

We claim:

1. A tillage support including a tool free adjustable harrow leveling bar, comprising:
a frame including a first support member and an extension arm coupled to said first support member;
a tensioning device coupled to said first support member and said extension arm;
a tension link coupled to said tensioning device and said first support member, wherein said tension link includes at least two coupling points;
a leveling bar mount arm rotatably coupled to said first support member, wherein said leveling bar mount arm includes at least one coupling point and is configured to independently rotate about a first axis; and
a coupling link configured to engage the coupling point of said leveling bar mount arm and at least one of the coupling points of said tension link,
wherein said coupling link is configured to be adjustable tool free.

2. The system of claim 1, wherein said extension arm includes an end capable of being coupled to additional tillage equipment.

3. The system of claim 2, wherein said additional tillage equipment is a rolling harrow basket.

4. The system of claim 1, wherein said at least one coupling point of said leveling bar is a receiving member, and said at least two coupling points of said tension link are receiving members.

5. The system of claim 4, wherein said coupling link is an elongate member configured to engage said at least one coupling point of said leveling bar and said at least two coupling points of said tension link.

6. The system of claim 5, wherein said elongate member is a pin.

7. The system of claim 1, wherein said leveling bar mount arm further includes a coupling plate including at least one coupling point configured to receive said coupling link.

8. The system of claim 1, further comprising a harrow leveling bar coupled to said leveling bar mount arm.

9. A tillage implement, comprising:
at least one tillage support frame including a first support member, an extension arm coupled to said first support member, a tensioning device coupled to said first support member and said extension arm, and a tension link coupled to said first support member and said tensioning device,
wherein said tension link includes at least two coupling points;
at least one tillage support member coupled to said first support member and including an end configured to couple to a farm implement;
at least one leveling bar mount arm rotatably coupled to said first support member, wherein said at least one leveling bar mount arm includes at least one coupling point and is configured to independently rotate about a first axis; and
at least one coupling link configured to engage the coupling point of said at least one leveling bar mount arm and at least one of the coupling points of said tension link,
wherein said at least one coupling link is configured to be adjustable tool free.

10. The tillage implement of claim 9, further comprising a rolling harrow basket coupled to an end of the extension arm.

11. The tillage implement of claim 9, further comprising a harrow leveling bar coupled to said at least one leveling bar mount arm.

12. A tillage support including a tool free adjustable harrow leveling bar, and further including a frame having a first support member and an extension arm coupled to said first support member, comprising:
means for tensioning coupled to said first support arm and said extension arm;
means for mounting an arm rotatably coupled to said first support arm, wherein said means for mounting an arm is configured to independently rotate about a first axis; and
means for linking said means for tensioning to said means for mounting an arm;
wherein said means for linking is configured to be adjustable tool free.

13. The system of claim 12, wherein said extension arm includes a means for coupling tillage equipment.

14. The system of claim 13, wherein means for mixing soil is coupled to said means for coupling tillage equipment.

15. The system of claim 12, further comprising a means for mixing soil coupled to said means for mounting an arm.
